(19) United States
(12) Patent Application Publication
(10) Pub. No.: US 2011/0150202 A1
(43) Pub. Date: Jun. 23, 2011

(54) AUTOMATIC DISCONNECTION SYSTEM AND METHOD OF A COMMUNICATION DEVICE

(75) Inventor: PO-FENG CHENG, Taoyuan (TW)

(73) Assignee: FOXCONN COMMUNICATION TECHNOLOGY CORP., Taoyuan County (TW)

(21) Appl. No.: 12/773,854

(22) Filed: May 5, 2010

(30) Foreign Application Priority Data
Dec. 17, 2009 (CN) 200910311740.6

(51) Int. Cl. H04M 3/42

(52) U.S. Cl. 379/207.03

(57) ABSTRACT

A system and a method for automatic disconnection of a phone call of a communication device include setting a critical time of the phone call, resetting a timer of the communication device when the communication device starts a phone call, and obtaining a local voice and a remote voice of the phone call. The system and method further include starting timing when determining both of the local voice and remote voice are inactive, and controlling the communication device to perform an auto disconnection of the phone call when the duration of inactivity exceeds the predetermined critical time.

### BACKGROUND

1. Field of the Invention

Embodiments of the present disclosure are related to communication technology, and in particular, to an automatic disconnection system and method of a communication device.

2. Description of Related Art

Some people may forget to lock the keypad of a communication device (e.g., a cell phone) or forget to press a button of the communication device to end a phone call when the phone call is finished, which can result in unnecessary phone charges.

What is needed, therefore, is an improved system and method for overcoming the aforementioned problem.

### BRIEF DESCRIPTION OF THE DRAWINGS

FIG. 1 is a block diagram of one embodiment of a communication device including an automatic disconnection system.

FIG. 2 is a flowchart of one embodiment of a method for determining active voice and inactive voice.

FIG. 3 is a flowchart of one embodiment of an auto disconnection method of the communication device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

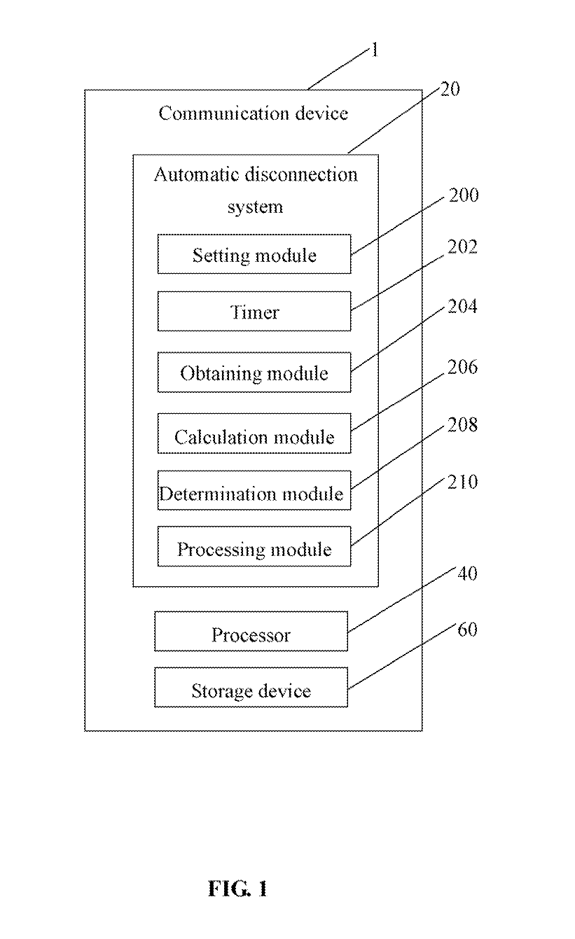

FIG. 1 is a block diagram of one embodiment of a communication device 1 including an auto disconnection system 20. In one embodiment, the auto disconnection system 20 may disconnect a phone call (e.g., hang up the phone call) automatically if the auto disconnection system 20 does not detect any voice from a caller and a receiver during a predetermined time interval, using voice activity detection (VAD) technology. In one embodiment, “disconnect” means disconnection communication between a caller and a callee. The communication device 1 includes a processor 40 and a storage device 60. The storage device 60 may be a memory of the communication device 1 and also may be an external storage card, such as a smart media (SM) card or secure digital (SD) card, for example.

In one embodiment, the auto disconnection system 20 comprises a setting module 200, a timer 202, an obtaining module 204, a calculation module 206, a determination module 208, and a processing module 210. The modules 200, 202, 204, 206, 208, and 210 may comprise one or more computerized codes to be executed by the processor 40 to perform one or more operations of the communication device 1. Details of these operations will be provided below.

The setting module 200 sets a critical time T of the phone call of the communication device, the critical time determining if the phone call of the communication device 1 needs to be disconnected. In one embodiment, the predetermined critical time T may be set as 5 seconds or 10 seconds. The setting module 200 further sets a first final threshold for a local voice and a second final threshold for a remote voice. It should be understood that “voice” is defined to include not only human voices of a caller/a callee, but background noise as well. The first final threshold and the second final threshold may be used to determine whether the local voice or the remote voice is inactive. Details will be provided below.

The VAD technology makes use of voice characteristic parameters (e.g., energy, zero-crossing rate, vocal tract area, pitch period, and spectral distortion) to calculate a quantification value of input voice, and uses the quantification value to determine the input voice is active or inactive. In one embodiment, an active voice may represent dialogue between two parties during a phone call. An inactive voice may represent a temporary suspension of dialog between the parties during the phone call.

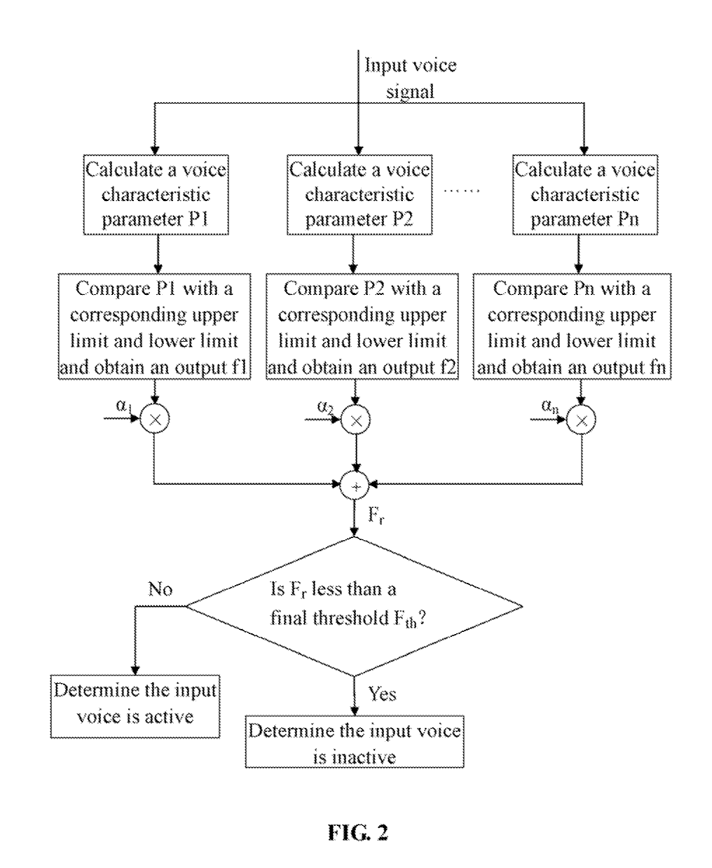

FIG. 2 is a flowchart of one embodiment of a method for determining active voice and inactive voice. First, voice characteristic parameters P1, P2 . . . Pn of an input voice signal are calculated. Then, each of the voice characteristic parameters are compared with corresponding predetermined upper limits and lower limits, to determine output values f1, f2 . . . fn. For example, the voice characteristic parameter P1 is compared with a corresponding upper limit and corresponding lower limit, to obtain a corresponding output value f1. In one embodiment, the corresponding upper limit of the voice characteristic parameter P1 is TH1_{U}, and the corresponding lower limit of the voice characteristic parameter P1 is TH1_{L}.

If P1 is greater than TH1_{U}, the input voice signal is determined to be active voice, and the output value f1 is “1.” If P1 is less than TH1_{L}, this input voice signal is determined to be inactive voice, and the output value f1 is “−1.” If P1 is greater than TH1_{L} and less than TH1_{U}, this input voice signal is also determined to be inactive voice, and the output value f1 is 0. Fᵣ is obtained using a formula of Fᵣ=(α₁*f1+α₂*f2 . . . αₙ*fn). The α₁, α₂ . . . αₙ represent weighted values of the voice characteristic parameters P1, P2 . . . Pn, and Fᵣ represents voice parameter quantification value. Finally, the calculated Fᵣ is compared with the final threshold Fₜₕ. If Fᵣ is less than Fₜₕ, the input voice signal is determined to be inactive voice. If Fᵣ is not less than Fₜₕ, the input voice signal is determined to be active voice.

The timer 202 starts timing a duration of inactivity of when both the local voice and remote voice of a phone call are determined to be inactive. In one embodiment, the duration of inactivity is represented as N, and the initial value of N is set to 0.

The obtaining module 204 obtains the local voice and the remote voice when the phone call of the communication device 1 is established. That is, the obtaining module 204 obtains the voice signal of a user of the communication device 1 and the voice signal of the other side of the phone call. In one embodiment, the obtaining module 204 obtains the local voice and the remote voice by collecting and recording the local voice and the remote voice.

The calculation module 206 analyzes the obtained local voice and remote voice, and calculates a voice parameter quantification value of the local voice and a voice parameter quantification value of the remote voice.

The determination module 208 determines whether both the local voice and remote voice are inactive. In one embodiment, if the voice parameter quantification value of the local voice is less than the first final threshold, and the voice parameter quantification value of the remote voice is also less than the second final threshold, the determination module 208 determines that both the local voice and remote voice are inactive. If the voice parameter quantification value of the local voice is less than the first final threshold, and the voice parameter quantification value of the remote voice is not less than the second final threshold, the determination module 208 determines the local voice is active and the remote voice is inactive. If the voice parameter quantification value of the local voice is not less than the first final threshold, and the voice parameter quantification value of the remote voice is less than the second final threshold, the determination module 208 determines the local voice is active and the remote voice is inactive. If the parameter of the local voice is not less than the first final threshold, and the voice parameter of the remote voice is not less than the second final threshold, the determination module 208 determines the local voice is active and the remote voice is inactive.

The determination module 208 further determines whether the duration N of inactivity exceeds the predetermined critical time T when both the local voice and remote voice are inactive.

The processing module 210 controls the communication device 1 to perform an auto disconnection of the phone call immediately when the duration of inactivity N exceeds the predetermined critical time T.

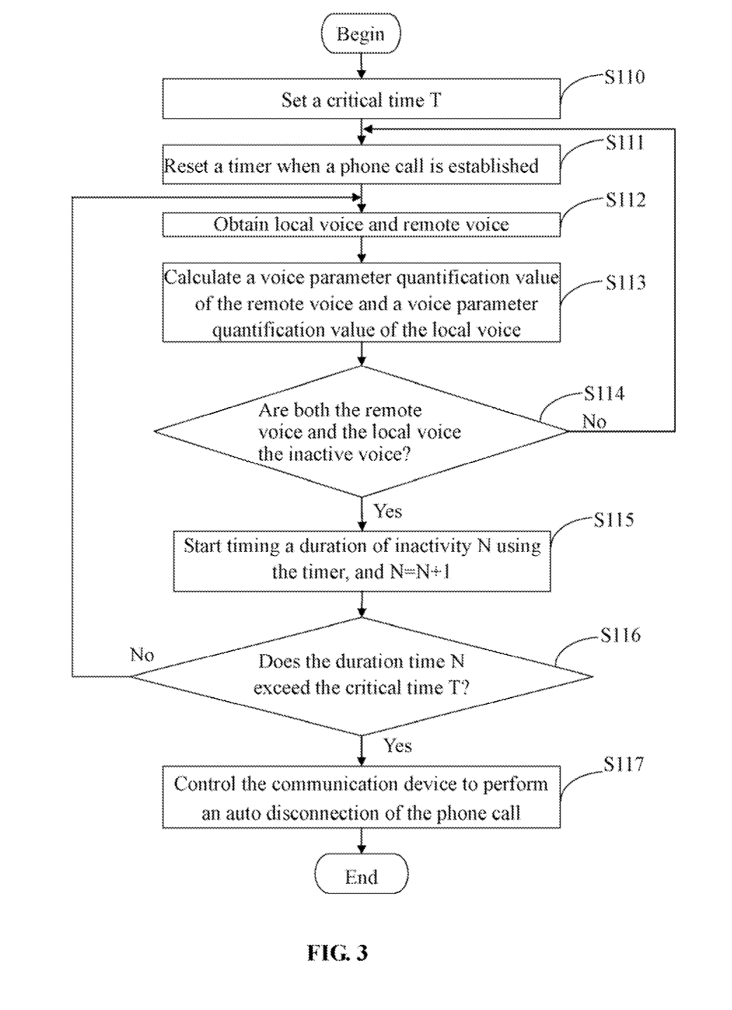

FIG. 3 is a flowchart of one embodiment of an auto disconnection method of the communication device of FIG. 1. Depending on the embodiment, additional blocks may be added, others removed, and the ordering of the blocks may be changed.

In block S110, The setting module 200 sets a critical time of the phone call, the critical time determining if the phone call needs to be disconnected, and sets a first final threshold of a local voice and a second final threshold of a remote voice. In one embodiment, the predetermined critical time T may be set as 5 seconds or 10 seconds, and both of the first final threshold and the second threshold may be set as 0.8.

In block S111, when the phone call of the communication device 1 is established, the timer 202 is reset, and the duration of inactivity N of the timer 202 is equal to 0.

In block S112, the obtaining module 204 obtains the local voice and the remote voice of the communication device 1.

In block S113, the calculation module 206 analyzes the obtained local voice and remote voice, and calculates a voice parameter quantification value of the local voice and a voice parameter quantification value of the remote voice.

In block S114, The determination module 208 determines whether both of the local voice and remote voice are inactive.

If both of the local voice and remote voice are inactive, in block S115, the timer 202 starts timing and calculates the duration of inactivity of the timer N=N+1. Otherwise, if one of the local voice and remote voice are active or both of the local voice and remote voice are active, the procedure turns back to S110.

In block S116, the determination module 208 further determines whether the duration of inactivity N exceeds the predetermined critical time T when both of the local voice and remote voice are inactive.

If the duration of inactivity N exceeds the predetermined critical time T, in block S117, the processing module 210 controls the communication device 1 to perform an auto disconnection of the phone call immediately. If the duration of inactivity N does not exceed the predetermined critical time T, the procedure turns back to S112.

It should be emphasized that the described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be comprised herein within the scope of this disclosure and the above-described inventive embodiments, and the present disclosure is protected by the following claims.

What is claimed is:

1. A communication method of a communication device, comprising:
setting a critical time of a phone call of the communication device, the critical time determining if the phone call of the communication needs to be disconnected;
resetting a timer of the communication device when the phone call of the communication device of the communication device is established;
obtaining local voice and remote voice of the communication device;
analyzing the obtained local voice and remote voice, and calculating a voice parameter quantification value of the local voice and a voice parameter quantification value of the remote voice;
determining whether both of the local voice and remote voice are inactive;
starting timing a duration of inactivity when both local voice and remote voice of the phone call are determined to be inactive using the timer;
determining whether the duration of inactivity exceeds the predetermined critical time; and
controlling the communication device to perform an auto disconnection of the phone call when the duration of inactivity exceeds the predetermined critical time.

2. The method as described in claim 1, further comprising:
returning to the step of resetting a timer of the communication device, if one of the local voice and remote voice is active or both of the local voice and remote voice are active.

3. The method as described in claim 1, further comprising:
returning to the step of obtaining local voice and remote voice, if the duration of inactivity does not exceed the predetermined critical time.

4. The method as described in claim 1, further comprising:
setting a final threshold of the local voice and a final threshold of the remote voice.

5. The method as described in claim 4, wherein the step of determining whether both of the local voice and remote voice are inactive comprises:
comparing the voice parameter of the local voice with the final threshold of the local voice, and comparing the voice parameter of the remote voice with the final threshold of the remote voice;
determining that the local voice is inactive if the voice parameter of the local voice is less than the final threshold of the local voice, and determining that the remote voice is inactive if the voice parameter of the remote voice is less than the final threshold of the remote voice.

6. A storage medium storing a set of instructions, the set of instructions capable of being executed by a processor to perform a communication method for a communication device, the method comprising:
setting a critical time of a phone call of the communication, the critical time determining if the phone call of the communication needs to be disconnected;
resetting a timer of the communication device when the phone call of the communication device is established;
obtaining local voice and remote voice of the communication device;
analyzing the obtained local voice and remote voice, and calculating a voice parameter quantification value of the local voice and a voice parameter quantification value of the remote voice;
determining whether both of the local voice and remote voice are inactive;
starting timing a duration of inactivity when both local voice and remote voice of the phone call are determined to be inactive using the timer;
determining whether the duration of inactivity exceeds the predetermined critical time; and
controlling the communication device to perform an auto disconnection of the phone call when the duration of inactivity exceeds the predetermined critical time.

7. The storage medium as described in claim 6, further comprising:
returning to the step of resetting a timer of the communication device, if one of the local voice and remote voice is active or both of the local voice and remote voice are active.

8. The storage medium as described in claim 6, further comprising:
returning to the step of obtaining local voice and remote voice, if the duration of inactivity does not exceed the predetermined critical time.

9. The storage medium as described in claim 6, wherein the method further comprises:
setting a final threshold of the local voice and a final threshold of the remote voice.

10. The storage medium as described in claim 6, wherein the method of determining whether both of the local voice and remote voice are inactive comprises:
comparing the voice parameter of the local voice with the final threshold of the local voice, and comparing the voice parameter of the remote voice with the final threshold of the remote voice;
determining that the local voice is inactive if the voice parameter of the local voice is less than the final threshold of the local voice, and determining that the remote voice is inactive if the voice parameter of the remote voice is less than the final threshold of the remote voice.

11. An auto disconnection system of a communication device, comprising:
a storage device;
at least one processor; and
one or more programs stored in the storage device and being executable by the at least one processor, the one or more programs comprising:
a setting module operable to set a critical time of the phone call of the communication device, the critical time determining if the phone call needs to be disconnected;
a timer operable to starting timing a duration of inactivity when both of the local voice and remote voice are inactive, and the initial duration of inactivity of the timer being set to 0;
an obtaining module operable to obtain local voice and remote voice of the communication device;
a calculation module operable to analyze the obtained local voice and remote voice, and calculate a voice parameter quantification value of the local voice and a voice parameter quantification value of the remote voice;
a determination module operable to determine whether both of the local voice and remote voice are inactive, and further operable to determine whether the duration of inactivity exceeds the predetermined critical time when both of the local voice and remote voice are inactive;
a processing module operable to controls the communication device to perform an auto disconnection of the phone call immediately.
when the duration of inactivity exceeds the predetermined critical time.

12. The system as described in claim 11, wherein the setting module further operable to set a final threshold of the local voice and a final threshold of the remote voice.

13. The system as described in claim 11, wherein the determination module determines whether both of the local voice and remote voice are inactive by the method of:
comparing the voice parameter of the local voice with the final threshold of the local voice, and comparing the voice parameter of the remote voice with the final threshold of the remote voice;
determining that the local voice is inactive if the voice parameter of the local voice is less than the final threshold of the local voice, and determining that the remote voice is inactive if the voice parameter of the remote voice is less than the final threshold of the remote voice.
